(19) United States
(12) Patent Application Publication
(10) Pub. No.: US 2022/0222679 A1
(43) Pub. Date: Jul. 14, 2022

(54) SYSTEMS AND METHODS FOR INTEGRATION OF E-COMMERCE DATA

(71) Applicant: Bit Gooey Inc., Salt Lake City, UT (US)

(72) Inventor: Christopher Alexander Burns, Salt Lake City, UT (US)

(21) Appl. No.: 17/149,021

(22) Filed: Jan. 14, 2021

(51) Int. Cl. G06Q 30/00; G06Q 40/00; G06F 16/27

(52) U.S. Cl. CPC G06Q 30/01; G06F 16/27; G06Q 40/12

(57) ABSTRACT

A system for facilitating the extraction, transformation, and loading of data, such as e-commerce order data, between a website CMS and a CRM system, such as a back-office CRM system. An adapter features a customizable interface that transforms website CMS data into an intermediary format. This intermediary data format allows the CRM system, website CMS, and e-commerce order integration to function as decoupled components.

### TECHNICAL FIELD

The present disclosure is related to electronic commerce (“e-commerce) data integration systems and methods, and more particularly to systems and methods for integrating e-commerce data with existing customer relationship management systems (“CRM”).

### BACKGROUND

As e-commerce websites continue to become increasingly prevalent, consumers are able to pay for a wide variety of goods and services online. For example, a consumer may pay for a parking ticket or a medical procedure online via an e-commerce website. However, a business that wants to launch, alter, or upgrade an e-commerce website may face difficulties. For example, the business may already utilize a CRM system. It may be difficult for the business to launch, alter, or upgrade an e-commerce website without modifying the existing CRM system, and modifying the existing CRM system may be risky and cost prohibitive. Accordingly, improvements in e-commerce data integration techniques are needed.

### SUMMARY

Methods and systems are disclosed for facilitating the integration of e-commerce data with an existing customer relationship management (CRM) system. A system for synchronizing data between a content management system (CMS) and a CRM system may comprise a first database associated with a CMS system and at least one computing device configured to create a secure connection between a CRM system and a second database. The secure connection between the CRM system and the second database may be a TCP connection between a driver on the CRM system and the second database. The TCP connection between the driver on the CRM system and the second database uses a certificate authority to validate client and server certificates.

The at least one computing device may be configured to receive, from the first database, customer data, order data, product data, and subscription data associated with the CMS system. It may be determined that at least one of the customer data, order data, product data, and subscription data associated with the CMS system is not synchronized with at least one of customer data, order data, product data, and subscription data stored in the second database. To synchronize the at least one of the customer data, order data, product data, and subscription data associated with the CMS system with at least one of customer data, order data, product data, and subscription data stored in the second database, at least one of the customer data, order data, product data, or subscription data stored in the second database may be generated, updated, or removed.

### BRIEF DESCRIPTION OF DRAWINGS

The accompanying drawings, which are incorporated in and constitute a part of this specification, illustrate embodiments and together with the description, serve to explain the principles of the methods and systems:

FIG. 1 illustrates a block diagram of an example system according to an embodiment of the present disclosure;

FIG. 2. illustrates a block diagram of an example CRM database connector according to an embodiment of the present disclosure;

FIG. 3 illustrates a flow chart of an example integration method according to an embodiment of the present disclosure; and

FIG. 4 illustrates of an example computing device according to an embodiment of the present disclosure.

### DETAILED DESCRIPTION

It may be advantageous for a company to offer goods or services for sale on an e-commerce website. For example, a company that offers goods or services for sale on an e-commerce website may be able to acquire and retain more customers. Many companies, including medium to large-sized businesses, employ back-office CRM software that functions independently from the company's e-commerce website. It may be desirable to have data associated with the existing CRM system to stay synchronized with customer data in a website CMS. By maintaining centralized and synchronized data, a company may be able to provide superior customer service as compared to a company that does not have synchronization between its CRM system and its website CMS. For example, a company that maintains centralized and synchronized data may be able to accurately review a customer's order history from the back- office CRM, regardless of the origin of the orders. Thus, a company that maintains centralized and synchronized data is at a competitive advantage.

However, a company that wants to launch, alter, or upgrade an e-commerce website may face difficulties if the company already utilizes a back-office CRM system. The company may need to alter, upgrade, or completely replace their website CMS, their CRM system, or both their website CMS and their CRM system at regular intervals. Each change in either the CRM system or the website CMS may require a substantial amount of engineering resources. A company with CMS requirements may require even more engineering resources. Such engineering resources are expensive and may be cost-prohibitive. Additionally, any change made to the CRM system or the website CMS may cause unforeseen issues that are difficult or impossible to calculate in advance. Accordingly, even for a business with substantial software engineering resources, modifying the CRM system or the CMS website may risky.

A company that wants to integrate its e-commerce website with an existing CRM system may face the above difficulties regardless of the type of product or service it sells and regardless of its size. Large, medium, or small-sized companies may all face the above difficulties when integrating an e-commerce website with an existing CRM system. For example, a live events and seminar company may already utilize a CRM system. The live events and seminar company may not have substantial software engineering resources. Due to the nature of the products in the CRM system and the website CMS—namely products based around event tickets—there may be a continuous element of change that may cause increased difficulties for the company if it wants to integrate its e-commerce website with its longstanding CRM system. If the live events and seminar company were to completely replace its website CMS, that may have an e-commerce integration with the back-office CRM system, then upgrading that e-commerce integration may be cost-prohibitive.

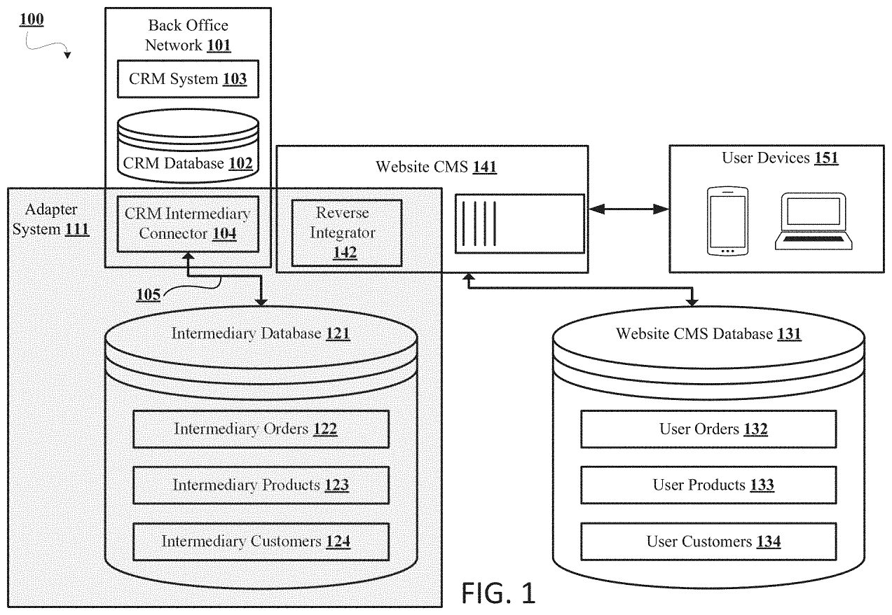

A company may want to integrate its new e-commerce website with its existing CRM system while avoiding the challenges described above. FIG. 1 illustrates an exemplary system 100 for integrating an e-commerce website with an existing CRM system. The system 100 may allow a company to avoid the expenses and risk associated with modifying an existing CRM system or website CMS by providing features that facilitate the integration of e-commerce data with an existing CRM system. The system 100 includes an adapter system with a customizable interface for the website CMS. The adapter system may be configured to transform the new website CMS orders into the same format as the CMS that is being replaced. Website CMS subscriptions (not shown in FIG. 1 to simplify the illustration) may be handled in the same manner as orders and may substituted for orders in FIG. 1. Once transformed, the new website CMS orders or subscriptions may be stored in an intermediary database. Storing the transformed new website CMS orders or subscriptions in the intermediary database may enable the existing integration between the website CMS and the back-office CRM system to continue to function without modification of the existing CRM system, website CMS, or the existing integration. While the system 100 may be most beneficial to a medium or large sized company, it can also benefit smaller or less well-established companies.

The system 100 includes a back-office network 101, an intermediary database 121, a website CMS 141, a website CMS database 131, an intermediary connection 105, an adapter system 111, and be configured to communicate with at least one user device 151. One or more of the back-office network 101, the intermediary database 121, the website CMS 141, or the website CMS database 131 may be associated with a business entity seeking to integrate its e-commerce data with an existing CRM system, such as the companies described above.

The back-office network 101 may be a network associated with a company. The back-office network 101 may include the back-office CRM components. For example, the back-office network 101 may include a CRM database 102, a CRM system 103, and a CRM intermediary connector 104. The CRM database 102 may house back-office CRM system data associated with the CRM system 103. The CRM system 103 may include a computer system within the back-office network 101 that executes an interface of the CRM intermediary connector 104. The CRM intermediary connector 104 may include an interface module configured to provide secure access to the intermediary database 121. For example, the interface module may be configured to provide secure access to the intermediary database 121 via the secure intermediary connection 105.

The secure intermediary connection 105 may be a connection, such as a TCP connection, between a driver, such as an Open DataBase Connectivity (ODBC) driver, on the CRM system 103 and the intermediary database 121. The secure intermediary connection 105 may be configured to use a certificate of authority to validate client or server certificates. In an embodiment, the secure intermediary connection 105 may be created using an ODBC data source that configures an X509 client certification that is signed by the certificate authority. An ODBC driver on the CRM system 103 and the intermediary database 121 may then establish the secure intermediary connection 105 to the intermediary database 121.

The adapter system 111 may include the CRM intermediary connector 104, the secure intermediary connection 105, the intermediary database 121, and a reverse integrator 142. The intermediary database 121 may store website CMS data in an intermediary format. For example, the intermediary database 121 may store website CMS data in the same format as a CMS that is being replaced. Website CMS data stored in the intermediary database 121 may include intermediary order data 122. The intermediary order data 122 may include website CMS orders that have been transformed. The intermediary database 121 may include intermediary product data 123. The intermediary product data 123 may include website CMS products that have been transformed. The intermediary database 121 may include intermediary customer data 124. The intermediary customer data 124 may include website CMS customer profiles that have been transformed.

The reverse integrator 142 may function as a customizable interface of the adapter system 111 for the website CMS 141. The website CMS 141 may be the website CMS at which customers place e-commerce orders. For example, customers may place e-commerce orders for products or services offered for sale on the website CMS 141. In an embodiment, the placed ordered may be stored in the website database 131. The reverse integrator 142 may transform the website CMS e-commerce data and store the transformed data in the intermediary database 121. For example, the reverse integrator 142 may transform the website CMS data into the same format as the CMS that is being replaced. The reverse integrator 142 facilitates the direct integration of the back-office CRM system 103 with the intermediary database 121. If the back-office CRM system 103 is directly integrated with the intermediary database 121, the back-office CRM system 103 may not integrate with the website CMS database 131. If the back-office CRM system 103 is not integrated with the website CSM database 131, the back-office CRM system 103 and the website CMS 141 may be decoupled.

The website CMS database 131 may be used by the website CMS 141 to store e-commerce order data, such as user order data 132. The user order data 132 may include website CMS orders in their original format, such as before they are transformed and stored in the intermediary database 121. The website CMS database 131 may be used by the website CMS 141 to store user product data, such as user product data 133. The user product data 133 may include website CMS products in their original format, such as before they are transformed and stored in the intermediary database 121. The website CMS database 131 may be used by the website CMS 141 to store user customer data, such as user customer data 134. The user customer data 134 may include website CMS customer profiles in their original format, such as before they are transformed and stored in the intermediary database 121.

The at least one user device 151 may be associated with at least one customer of the website CMS 141. For example, the at least one user device 151 may belong to at least one customer that makes at least one e-commerce purchase on the website CMS 141. If the at least one customer uses the at least one user device 151 to place an e-commerce order via the website CMS 141, these placed orders may be stored in the website CMS database 131. The at least one user device 151 may be comprised of any of a variety of different types of wireless devices, including for example, a smartphone, a tablet computer, a laptop computer, a notebook computer, a personal computer, other consumer electronics, and the like.

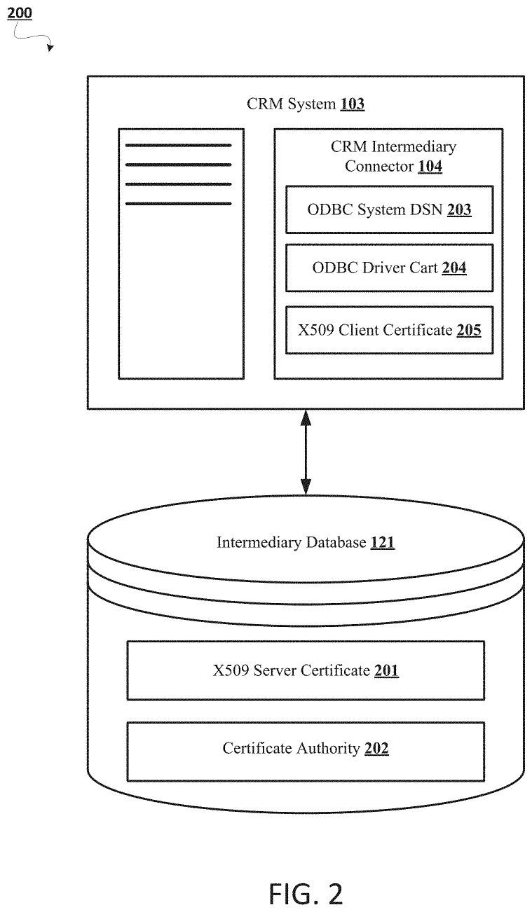

FIG. 2 illustrates an exemplary CRM database connector 200, such as the secure intermediary connection 105 of FIG. 1. The CRM database connector 200 may be configured to create a secure connection between a CRM system, such as the CRM system 103, and an intermediary database, such as the intermediary database 121 of FIG. 1. The secure connection between the CRM system and the intermediary database may facilitate the integration of e-commerce orders between the website CMS, such as the website CMS 141, and the CRM system. The CRM database connector 200 may include a CRM system, such as the CRM system 103, a CRM intermediary connector, such as the CRM intermediary connector 104, and an intermediary database, such as the intermediary database 121.

The CRM intermediary connector 104 may include a system DSN 203, a driver cart 204, and a client certificate 205. The system DSN 203 may be an ODBC system DSN. The system DSN 203 may include a set of configurations containing all information necessary for the driver cart 204 to establish a secure intermediary connection, such as the secure intermediary connection 105, between the CRM system 103 and the intermediary database 121. The driver cart 204 may be an ODBC driver. The driver cart 204 may include a module configured to establish connections and enable communication between the operating system and a specific database, such as the intermediary database 121. The client certificate 205 may be a X509 client certificate. The client certificate 205 may be a certificate that is presented by the driver cart 204 to the intermediary database 121 in order to allow validation of the client's identity.

The intermediary database may include a server certificate 201 and a certificate authority 202. The server certificate 201 may be an X509 server certificate. The server certificate 201 may be a certificate that is presented by a socket server to connecting clients in order to allow clients to validate the identity of the server. The certificate authority 202 may include cryptographic data that may be used to sign certificates and validate signed certificates.

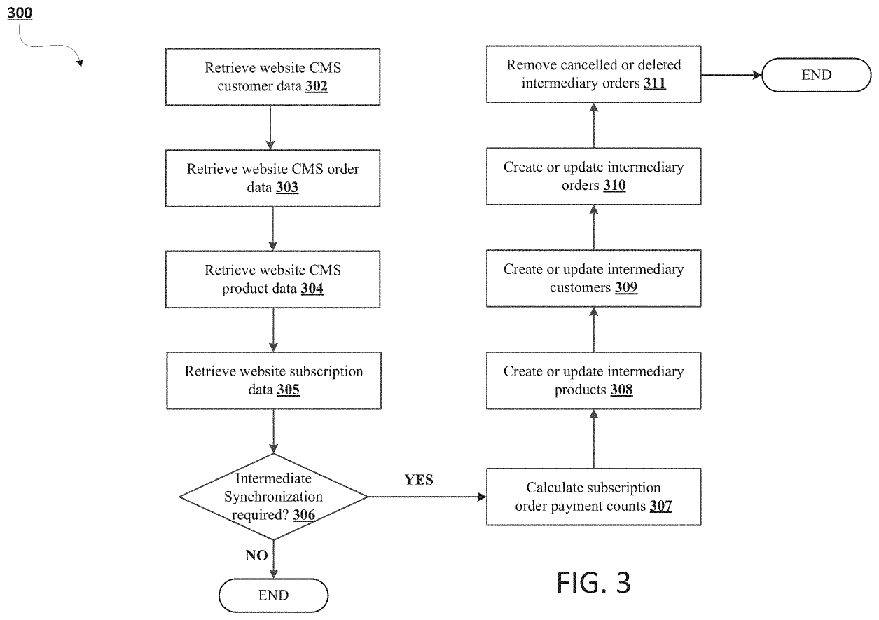

The reverse integrator module 142 of FIG. 1 may implement a number of the functions and techniques described herein. For example, as illustrated in FIG. 3, the reverse integrator module 142 may implement a method 300 to transform website order data into an intermediary format. The reverse integrator module 142 may implement the method 300 at scheduled intervals. Once website order data is transformed into the intermediary format, the website order data may be stored in an intermediary database, such as the intermediary database 121. The reverse integrator module 142 may function as a customizable interface to an adapter, such as the adapter system 111, for a website CMS, such as the website CMS 141.

At step 302, website CMS customer data may be retrieved. For example, the reverse integrator module 142 may retrieve CMS customer data from the website CMS database 131. The CMS customer data may, for example, be the user customer data 134 stored in the website CMS database 131. As discussed above, the user customer data 134 may include website CMS customer profiles in their original format, such as before they are transformed and stored in the intermediary database 121. At step 303, website CMS order data may be retrieved. For example, the reverse integrator module 142 may retrieve CMS order data from the website CMS database 131. The CMS order data may, for example, be the user order data 132 stored in the website CMS database 131. As discussed above, the user order data 132 may include website CMS orders in their original format, such as before they are transformed and stored in the intermediary database 121. At step 304, website CMS product data may be retrieved. For example, the reverse integrator module 142 may retrieve CMS product data from the website CMS database 131. The CMS product data may, for example, be the user product data 133 stored in the website CMS database 131. As discussed above, the user product data 133 may include website CMS products in their original format, such as before they are transformed and stored in the intermediary database 121. At step 305, website subscription data may be retrieved. For example, the reverse integrator module 142 may retrieve CMS subscription data from the website CMS database 131. The CMS subscription data may, for example, be the user subscription data stored in the website CMS database 131. As discussed above, the user subscription data may include website CMS subscriptions in their original format, such as before they are transformed and stored in the intermediary database 121.

At step 306, it may be determined if intermediate synchronization is required. Immediate synchronization may be required if any data retrieved in steps 302-305 requires synchronization from the CMS database 131 to the intermediate database 121. As discussed above, it may be desirable to have data associated with the CRM system to stay synchronized with data in the website CMS. By maintaining centralized and synchronized data, a company may be able to provide superior customer service as compared to a company that does not have synchronization between its CRM system and its website CMS. For example, a company that maintains centralized and synchronized data may be able to accurately review a customer's order history from the back-office CRM, regardless of the origin of the orders.

If intermediate synchronization is not required, the method 300 may terminate. If intermediate synchronization is required, the method 300 may proceed to step 307. At step 307, subscription order payment counts may be calculated. Based on the calculation, at step 308, intermediary products may be created or updated. For example, the reverse integrator module 142 may create or updated intermediary products. The intermediary products may, for example, be the intermediary product data 123 stored in the intermediary database 121. As discussed above, the intermediary product data 123 may include website CMS products that have been transformed into an intermediary format. Likewise, at step 309, intermediary customers may be created or updated. For example, the reverse integrator module 142 may create or updated intermediary customers. The intermediary customers may, for example, be the intermediary customer data 124 stored in the intermediary database 121. As discussed above, the intermediary customer data 124 may include website CMS customer data that has been transformed into an intermediary format. Likewise, at step 310, intermediary orders may be created or updated. For example, the reverse integrator module 142 may create or updated intermediary orders. The intermediary orders may, for example, be the intermediary order data 122 stored in the intermediary database 121. As discussed above, the intermediary order data 122 may include website CMS order data that has been transformed into an intermediary format.

At step 311, cancelled, refunded, or deleted intermediary orders may be removed from the intermediary database 121. For example, the reverse integrator module 142 may remove, from the intermediary database 121, orders that have been cancelled, refunded, or deleted from the website CMS database 131. Once cancelled or deleted intermediary orders are removed, the method 300 may terminate.

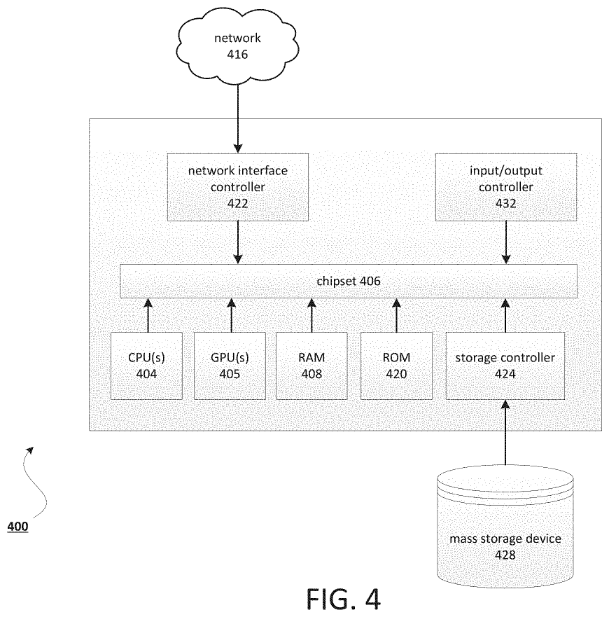

FIG. 4 depicts a computing device that may be used in various aspects. With regard to the example system of FIG. 1, one or more of the back-office network 101, the intermediary database 121, the website CMS 141, the website CMS database 131, the intermediary connection 105, the adapter system 111, or the at least one user device 151 may be implemented in an instance of a computing device 400 of FIG. 4. The computer architecture shown in FIG. 4 shows a conventional server computer, workstation, desktop computer, laptop, tablet, network appliance, PDA, e-reader, digital cellular phone, or other computing node, and may be utilized to execute any aspects of the computers described herein, such as to implement the methods described in FIG. 3.

The computing device 400 may include a baseboard, or “motherboard,” which is a printed circuit board to which a multitude of components or devices may be connected by way of a system bus or other electrical communication paths. One or more central processing units (CPUs) 404 may operate in conjunction with a chipset 406. The CPU(s) 404 may be standard programmable processors that perform arithmetic and logical operations necessary for the operation of the computing device 400.

The CPU(s) 404 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 404 may be augmented with or replaced by other processing units, such as GPU(s) 405. The GPU(s) 405 may comprise processing units specialized for but not necessarily limited to highly parallel computations, such as graphics and other visualization-related processing.

A user interface may be provided between the CPU(s) 404 and the remainder of the components and devices on the baseboard. The interface may be used to access a random access memory (RAM) 408 used as the main memory in the computing device 400. The interface may be used to access a computer-readable storage medium, such as a read-only memory (ROM) 420 or non-volatile RAM (NVRAM) (not shown), for storing basic routines that may help to start up the computing device 400 and to transfer information between the various components and devices. ROM 420 or NVRAM may also store other software components necessary for the operation of the computing device 400 in accordance with the aspects described herein. The user interface may be provided by a one or more electrical components such as the chipset 406.

The computing device 400 may operate in a networked environment using logical connections to remote computing nodes and computer systems through local area network (LAN) 416. The chipset 406 may include functionality for providing network connectivity through a network interface controller (NIC) 422, such as a gigabit Ethernet adapter. A NIC 422 may be capable of connecting the computing device 400 to other computing nodes over a network 416. It should be appreciated that multiple NICs 422 may be present in the computing device 400, connecting the computing device to other types of networks and remote computer systems.

The computing device 400 may be connected to a storage device 428 that provides non-volatile storage for the computer. The storage device 428 may store system programs, application programs, other program modules, and data, which have been described in greater detail herein. The storage device 428 may be connected to the computing device 400 through a storage controller 424 connected to the chipset 406. The storage device 428 may consist of one or more physical storage units. A storage controller 424 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 400 may store data on a storage device 428 by transforming the physical state of the physical storage units to reflect the information being stored. The specific transformation of a physical state may depend on various factors and on different implementations of this description. Examples of such factors may include, but are not limited to, the technology used to implement the physical storage units and whether the storage device 428 is characterized as primary or secondary storage and the like.

For example, the computing device 400 may store information to the storage device 428 by issuing instructions through a storage controller 424 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 400 may read information from the storage device 428 by detecting the physical states or characteristics of one or more particular locations within the physical storage units.

In addition or alternatively to the storage device 428 described herein, the computing device 400 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 400.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A storage device, such as the storage device 428 depicted in FIG. 4, may store an operating system utilized to control the operation of the computing device 400. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The storage device 428 may store other system or application programs and data utilized by the computing device 400.

The storage device 428 or other computer-readable storage media may also be encoded with computer-executable instructions, which, when loaded into the computing device 400, transforms the computing device from a general-purpose computing system into a special-purpose computer capable of implementing the aspects described herein. These computer-executable instructions transform the computing device 400 by specifying how the CPU(s) 404 transition between states, as described herein. The computing device 400 may have access to computer-readable storage media storing computer-executable instructions, which, when executed by the computing device 400, may perform the methods described in relation to FIG. 3.

A computing device, such as the computing device 400 depicted in FIG. 4, may also include an input/output controller 432 for receiving and processing input from a number of input devices, such as a keyboard, a mouse, a touchpad, a touch screen, an electronic stylus, or other type of input device. Similarly, an input/output controller 432 may provide output to a display, such as a computer monitor, a flat-panel display, a digital projector, a printer, a plotter, or other type of output device. It will be appreciated that the computing device 400 may not include all of the components shown in FIG. 4, may include other components that are not explicitly shown in FIG. 4, or may utilize an architecture completely different than that shown in FIG. 4.

As described herein, a computing device may be a physical computing device, such as the computing device 400 of FIG. 4. A computing node may also include a virtual machine host process and one or more virtual machine instances. Computer-executable instructions may be executed by the physical hardware of a computing device indirectly through interpretation and/or execution of instructions stored and executed in the context of a virtual machine.

One skilled in the art will appreciate that the systems and methods disclosed herein may be implemented via a computing device that may comprise, but are not limited to, one or more processors, a system memory, and a system bus that couples various system components including the processor to the system memory. In the case of multiple processors, the system may utilize parallel computing.

For purposes of illustration, application programs and other executable program components such as the operating system are illustrated herein as discrete blocks, although it is recognized that such programs and components reside at various times in different storage components of the computing device, and are executed by the data processor(s) of the computer. An implementation of service software may be stored on or transmitted across some form of computer-readable media. Any of the disclosed methods may be performed by computer-readable instructions embodied on computer-readable media. Computer-readable media may be any available media that may be accessed by a computer. By way of example and not meant to be limiting, computer-readable media may comprise “computer storage media” and “communications media.” “Computer storage media” comprise volatile and non-volatile, removable and non-removable media implemented in any methods or technology for storage of information such as computer-readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer. Application programs and the like and/or storage media may be implemented, at least in part, at a remote system.

As used in the specification and the appended claims, the singular forms “a,” “an” and “the” include plural referents unless the context clearly dictates otherwise. Ranges may be expressed herein as from “about” one particular value, and/or to “about” another particular value. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect.

It will be apparent to those skilled in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A system for synchronizing data between a content management system (CMS) and a customer relationship management (CRM) system, the system comprising:
a first database associated with the CMS;
an adapter system including a reverse integrator configured to decouple the CMS from the CRM system; and
at least one computing device configured to create a secure connection between the CRM system and a second database and to directly integrate the CRM system with the second database, the at least one computing device further configured to:
receive, from the first database through the adapter system, customer data, order data, product data, and subscription data associated with the CMS;
determine that at least one of the customer data, order data, product data, and subscription data associated with the CMS is not synchronized with at least one of the customer data, the order data, the product data, and the subscription data stored in the second database; and
at least one of generate, update, or remove at least one of the customer data, the order data, the product data, or the subscription data stored in the second database to synchronize the at least one of the customer data, the order data, the product data, and the subscription data associated with the CMS with at least one of the customer data, the order data, the product data, and the subscription data stored in the second database.

2. The system of claim 1, wherein the at least one computing device is configured to remove, from the second database, order data associated with orders that have been at least one of refunded, cancelled, or deleted from the first database.

3. The system of claim 1, wherein the secure connection between the CRM system and the second database is a TCP connection between a driver on the CRM system and the second database.

4. The system of claim 3, wherein the TCP connection between the driver on the CRM system and the second database uses a certificate authority to validate client and server certificates.

5. The system of claim 1, wherein the at least one computing device is further configured to transform the at least one of the customer data, the order data, the product data, and the subscription data stored in the second database from a first format associated with the CMS to a second format associated with a replacement CMS.

6. The system of claim 1, wherein at least one of the CRM system or the CMS is associated with a live events company.

7. A system for synchronizing data between a content management system (CMS) and a customer relationship management (CRM) system, the system comprising:
a first database associated with a CMS;
at least one computing device configured to create a secure connection between a CRM system and a second database, the at least one computing device configured to:
receive, from the first database, data associated with the CMS;
determine that the data associated with the CMS is not synchronized with data stored in the second database; and
at least one of generate or update the data stored in the second database to synchronize the data associated with the CMS and the data stored in the second database.

8. The system of claim 7, wherein the at least one computing device is further configured to:
remove, from the second database, data stored in the second database to synchronize the data associated with the CMS and the data stored in the second database.

9. The system of claim 8, wherein the data removed from the second database includes data associated with orders that have been at least one of refunded, cancelled, or deleted from the first database.

10. The system of claim 7, wherein the data associated with the CMS includes at least one of customer data, order data, product data, or subscription data.

11. The system of claim 7, wherein the secure connection between the CRM system and the second database is a TCP connection between a driver on the CRM system and the second database.

12. The system of claim 7, wherein the TCP connection between the driver on the CRM system and the second database uses a certificate authority to validate client and server certificates.

13. The system of claim 7, wherein the at least one computing device is further configured to treat the CRM system and the CMS as decoupled components.

14. The system of claim 7, wherein at least one of the CRM system or the CMS is associated with a live events company.

15. A method comprising:
receiving, from a first database associated with a content management system (CMS), data associated with the CMS;
determining, via a device configured to create a secure connection between a CRM system and a second database, that the data associated with the CMS is not synchronized with data stored in the second database; and
at least one of generating or updating the data stored in the second database to synchronize the data associated with the CMS and the data stored in the second database.

16. The method of claim 15, further comprising:
removing, from the second database, data stored in the second database to synchronize the data associated with the CMS and the data stored in the second database.

17. The method of claim 16, wherein the data removed from the second database includes data associated with orders that have been at least one of refunded, cancelled, or deleted from the first database.

18. The method of claim 15, wherein the data associated with the CMS includes at least one of customer data, order data, product data, or subscription data.

19. The method of claim 15, wherein the secure connection between the CRM and the second database is a TCP connection between a driver on the CRM system and the second database.

20. The method of claim 15, wherein the TCP connection between the driver on the CRM system and the second database uses a certificate authority to validate client and server certificates.
